(19) United States
(12) Patent Application Publication
(10) Pub. No.: US 2022/0190325 A1
(43) Pub. Date: Jun. 16, 2022

(54) PARTICLES IN ELECTROSPUN POLYMER FIBERS WITH THERMAL RESPONSE PROPERTIES

(71) Applicant: Nano and Advanced Materials Institute Limited, Hong Kong (HK)

(72) Inventors: Chi Ho KWOK, Hong Kong (HK); Wing Yin YUNG, Hong Kong (HK); Wing Lung HON, Hong Kong (HK); Shengbo LU, Hong Kong (HK); Chenmin LIU, Hong Kong (HK)

(21) Appl. No.: 17/543,657

(22) Filed: Dec. 6, 2021

Related U.S. Application Data
(60) Provisional application No. 63/125,976, filed on Dec. 16, 2020.

(51) Int. Cl. H01M 4/36; D01D 5/00; H01M 10/0525; H01M 4/525; H01M 4/505

(52) U.S. Cl. CPC H01M 4/366; D01D 5/0038; B82Y 30/00; H01M 4/525; H01M 4/505; H01M 10/0525

(57) ABSTRACT

The preset invention provides an electrode structure for a lithium ion battery comprising an electrode selected from a cathode including a lithium-based material or an anode including a conductive material, and a melt-convertible encapsulation layer covering at least one surface layer of the electrode. The melt-convertible encapsulation layer comprises a network of nanofibers having the diameter ranging approximately from 100 to 300 nm and polymer microspheres embedded in and coated on the nanofibrous network, wherein the ratio of the diameter of the polymer microspheres to the diameter of the nanofiber is over 30. The polymer microspheres melt to form a dielectric coating of the electrode so as to prevent fire or thermal runaway at a temperature approximately from 100 to 200° C.

### CROSS-REFERENCE TO RELATED APPLICATIONS

The present application claims priority from the U.S. provisional patent application No. 63/125,976 filed Dec. 16, 2020, and the disclosure of which is incorporated by reference in its entirety.

### FIELD OF THE INVENTION

The present invention relates to an electrode structure for a lithium ion battery, in particular with polymer microspheres embedded in and coated on a nanofibrous network thereof for fire or thermal runaway prevention at a predetermined temperature.

### BACKGROUND

With a rapid development of portable electronic devices and electric vehicles, lithium-ion batteries have dominated in the market over the last decade. However, many of the current lithium-ion batteries encounter safety issues such as thermal runaway (TR) and TR-induced smoke, fire and explosion, which have been recognized as the major causes to the accidents arising from or related to the failure of lithium ion battery.

Abuse conditions are the main sources for TR including mechanical abuse (crush, penetration and drop, etc.), electrochemical abuse (short-circuit, overcharge and over-discharge, etc.), and thermal abuse (fire, thermal shock, and overheat, etc.). When the abuse is over the tolerance, it would initiate the thermal runaway to an unstoppable chain reaction. The temperature rises rapidly within milliseconds and the energy stored is suddenly released, thereby inducing a number of exothermic reactions including decomposition of the solid electrolyte interface (SEI) layer, oxidative/reductive decomposition of organic electrolytes at the anode/cathode surface, separator melt-down and the thermal decomposition of the material at the cathode. Meanwhile, the internal pressure will also build up in a short period of time and more heat would be generated, which in turn burns the electrolyte and ignites fire.

In a recently published PCT application WO2021189459, an electrochemical device including electrodes and a separation layer is provided, where the separation layer includes a nanofibrous and porous structure filled with polymer particles having a melting point of 70 to 150° C. When the polymer particles melt, the pores of the nanofibrous and porous structure will be filled up by the molten polymer particles in order to lower the porosity of the structure, thereby enhancing the self-discharge problem, lowering the K value, and resolving the short-circuit problem due to potential rupture of the separation layer by the particles. However, this patent application requires the polymer particles be partially embedded into the pores of the nanofibrous network while partially exposed out of the pores on a surface distal to the surface which is more proximal to the electrodes, by which the risk of rupture of the separation layer by the particles on both electrodes is lowered. In other words, the polymer particles in that patent applications are configured to occupy part of a surface of the separation layer which is distal to the electrodes. On the other hand, the polymers forming the nanofibrous and porous structure have relatively higher melting point (170° C.) such that in high temperature the nanofibrous network will remain intact, while the molten polymer particles will fill up the pores in order to block the thermal runway. Therefore, a relatively high porosity must be provided in the separation layer of that patent application. In some embodiments, the porosity is at least 35% and up to 90-95%.

To achieve that configuration, WO2021189459 requires a specific layering sequence, i.e., each of anode and cathode layers is put with one separation layer. In the case where there are more than one pair of anode and cathode layers, multiple separation layers will be stacked on at least one surface of each of the anode and cathode layers in order to form a stack of multi-layered structure. From the performance and large-scale manufacturing cost-effectiveness points of view, the structure and method provided in that patent application have some rooms for improvement such as the requirement for partially embedding the polymer particles into the pores of the separation layer is difficult to control, dispersity of the polymer particles is too low to achieve a high surface area-to-volume ratio of the separation layer (for maximizing the efficiency of blocking the thermal runway when the particles melt), an increase in manufacturing time and cost for stacking the separation layer on each of the anode and cathode layers in the configuration disclosed in that application when the device is required to be in multilayered structure. Also, the melting point of the nanofibrous and porous structure of that patent application is too low to withstand a high-energy consumption device such as electric vehicle application.

Therefore, there is a need in the art for a new type of design for the electrode structure of lithium ion batteries, which is able to react immediately and to hinder the thermal runaway reaction in a short time period.

### SUMMARY OF THE INVENTION

The present invention is not to be limited in scope by any of the following descriptions. The following examples or embodiments are presented for exemplification only.

Accordingly, a first aspect of the present invention provides an electrode structure for a lithium ion battery. The electrode structure includes an electrode or an anode, and a three-dimensional structure with nanofiber bonded microspheres forming a melt-convertible encapsulation layer. The cathode includes a lithium-based material selected from the group consisting of Lithium Manganese Oxide (LMO), Lithium Cobalt Oxide (LCO), Lithium Nickel Manganese Cobalt Oxide (NMC), and Lithium Iron Phosphate (LFP). The anode includes a conductive material selected from the group consisting of carbon black, carbon nanotubes, graphene, and graphite. The melt-convertible encapsulation layer includes a network of nanofibers for carrying polymer microspheres on the electrode surface via stacking of layers of polymer microspheres-coated polymer nanofiber interconnecting network, where the polymer microspheres are embedded in and coated on at least one surface of the melt-convertible encapsulation layer. The diameter of the nanofiber is approximately from 100 to 300 nm and the ratio of the diameter of the polymer microspheres to the diameter of the nanofiber is over 30. A mass ratio of the polymer microspheres to the polymer nanofibers of the melt-convertible encapsulation layer is at least 3:1. The polymer microspheres are embedded in and coated on at least one surface of the nanofibrous network such that the polymer microspheres melt to form a dielectric coating of the electrode so as to prevent fire or thermal runaway at a temperature approximately from 100 to 200° C.

In a first embodiment of the first aspect of the present invention, there is provided an electrode structure for a lithium ion battery where the polydispersity of the polymer microspheres in the network of nanofibers ranges approximately from 0.6 to 1.0.

In a second embodiment of the first aspect of the present invention, there is provided an electrode structure for a lithium ion battery where the nanofibers comprise one or more polymers of polyvinylidene fluoride (PVDF), Poly(vinylidene fluoride-co-hexafluoropropylene) (PVDF-HFP), polyimide (PI), polyethylene (PE), and polypropylene (PP).

In a third embodiment of the first aspect of the present invention, there is provided an electrode structure for a lithium ion battery where the polymer microspheres comprise one or more polymers of polyvinylidene fluoride (PVDF), Poly(vinylidene fluoride-co-hexafluoropropylene)(PVDF-HFP), polyethylene (PE), and polypropylene (PP).

In a fourth embodiment of the first aspect of the present invention, there is provided an electrode structure for a lithium ion battery where the melting point of the nanofibers ranges approximately from 180 to 200° C. and the decomposition temperature of the nanofibers ranges approximately from 300 to 500° C.

In a fifth embodiment of the first aspect of the present invention, there is provided an electrode structure for a lithium ion battery where the melting point of the polymer microspheres ranges approximately from 80 to 200° C. and the decomposition temperature of the polymer microspheres approximately from 300 to 500° C.

In a sixth embodiment of the first aspect of the present invention, there is provided an electrode structure for a lithium ion battery where the porosity of the network of the nanofibers is approximately from 50 to 90%.

In a seventh embodiment of the first aspect of the present invention, there is provided an electrode structure for a lithium ion battery where the coverage rate of the melt-convertible encapsulation layer covering at least one surface layer of the electrode is approximately from 50 to 80%.

In an eighth embodiment of the first aspect of the present invention, there is provided an electrode structure for a lithium ion battery where the melt-convertible encapsulation layer is fabricated by one or more methods selected from electrospinning, electrospraying and blowspinning, preferably one or both of electrospinning and blowspinning.

In a ninth embodiment of the first aspect of the present invention, there is provided an electrode structure for a lithium ion battery where the thickness of the melt-convertible encapsulation layer is approximately from 10-50 μm.

In a further embodiment, the polymer microspheres have an average size of 1 to 10 μm. Preferably, the average size of the polymer microspheres is from 1 to 3 μm.

In yet a further embodiment, the diameter of the polymer nanofibers is from 100 to 300 nm.

In an additional embodiment, the diameter of the polymer microspheres to the diameter of the polymer nanofibers has a ratio of 30.

There is also provided a lithium ion battery including the electrode structure of the present invention, which includes at least an anode, a cathode, a separator and at least one three-dimensional nanofiber-microspheres-incorporated, melt-convertible encapsulation layer being applied on at least one surface of each of the anode and cathode in the absence of an order that the anode must be followed by an encapsulation layer, the separator, and then another encapsulation layer followed by the cathode, or vice versa. In other words, the electrode structure may be a multilayered structure including more than one anode and more than one cathode, and in that case, the encapsulation layer is not necessarily applied to each of the pair of anode and cathode following the afore-mentioned order, because polymer microspheres in the present invention are not required to be partially embedded into pores of the encapsulation layer and partially exposed out of those pores to avoid rupture of the encapsulation layer by the polymer microspheres, because the polymer microspheres in the present invention are mostly coated on the polymer nanofibers instead of requiring embedding the same into the pores of the nanofibrous structure, as in the prior art.

### BRIEF DESCRIPTION OF THE DRAWINGS

Embodiments of the present invention are described in more detail hereinafter with reference to the drawings.

FIG. 1A and FIG. 1B illustrate a melt-convertible encapsulation layer including nanofibers and polymer microspheres coating on at least one surface of the electrode.

FIGS. 2A to 2D shows the polymer microspheres embedding in the network of the nanofibers.

FIG. 3 illustrates the coating of the melt-convertible encapsulation layer on both surfaces of the electrode according to one embodiment of the present invention.

FIG. 4 shows the formation of the dielectric coating on the electrode after a thermal treatment at 100° C.

FIG. 5 shows the result of short circuit test (curve of Temperature-Time). The thickness of the melt-convertible encapsulation layer is approximately 35.8 μm for B79A and 35.4 μm for B79B, respectively.

FIG. 6 are SEM images showing the formation of the dielectric coating on the electrode after short circuit test.

FIG. 7 shows the result of nail penetration test (change of Temperature against Time). The thickness of the melt-convertible encapsulation layer for B79C is approximately 36.9 μm while that for B79D is 36.5 μm.

FIG. 8A is an SEM image showing the formation of the dielectric coating on the electrode close to the nail penetration area.

FIG. 8B is an SEM image showing no dielectric coating formation on the electrode away from the penetration area after the test.

### DEFINITION

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### DETAILED DESCRIPTION

The present invention provides an electrode structure for a lithium ion battery. The electrode structure includes an electrode or/and an anode, and a melt-convertible encapsulation layer. The encapsulation layer includes a network of nanofibers and polymer microspheres. Advantageously, the polymer microspheres are embedded in the nanofibrous network such that the polymer microspheres melt to form a dielectric coating of the electrode so as to prevent fire or thermal runaway at a temperature approximately from 80 to 300° C.

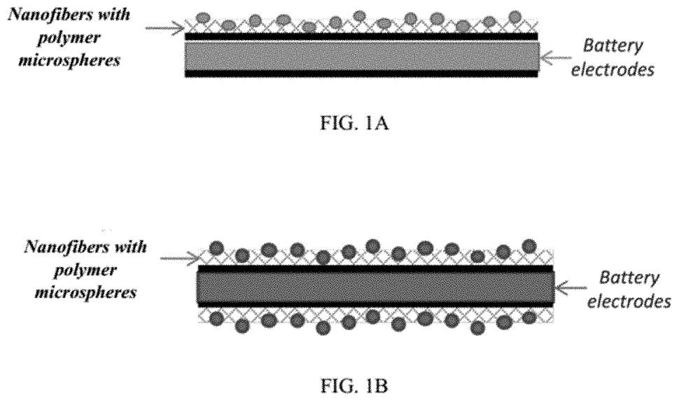

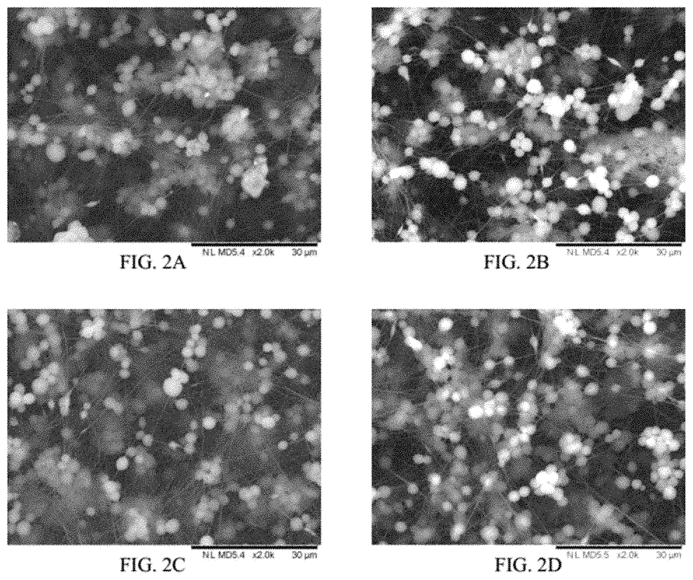

As shown in FIGS. 1A and 1B, the melt-convertible encapsulation layer includes a network of nanofibers and polymer microspheres coated uniformly on at least one side of the electrode. Furthermore, the polymer microsphere is embedded in the nanofibrous network shown in FIG. 2A to 2D. The diameter of the nanofibers in the network is approximately from 100 to 500 nm, and the size of the polymer microspheres is approximately from 1 to 10 μm. Preferably, the nanofibers in the network may have the diameter in the range of about 100 to 300 nm and the polymer microspheres may have the size in the range of about 1 to 3 μm. With respect to the diameter of the nanofibers, the ratio of the diameter of the polymer microspheres to the diameter of the nanofiber is over 30. Preferably, the ratio of the diameter of the polymer microspheres to the diameter of the nanofiber is 50. Furthermore, the thickness of the melt-convertible encapsulation layer is approximately from 10 to 50 μm. Preferably, the melt-convertible encapsulation layer may have the thickness in the range of about 10 to 30 μm.

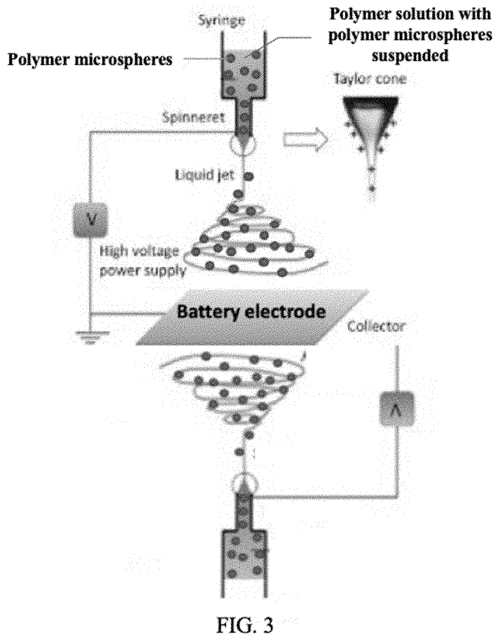

The melt-convertible encapsulation layer is prepared by dispersing the polymer microspheres in the polymer solution. Then, the polymer solution with the polymer microsphere dispersion is electrically charged and forming a so-called “Taylor cone” such that the polymer solution begins to be drawn out from the tip of the needle to the collector where the electrode is positioned as shown in FIG. 3. Methods for fabricating this encapsulation layer include, but not limited to, electrospinning, electro spraying and blow spinning, or any combination thereof, but preferably one or both of electrospinning and blowspinning. The solvents to prepare the polymer solution include, for example, but not limited to Dimethylformamide (DMF), Dimethylacetamide (DMAc) and Acetone, etc. The polymer microspheres may be dispersed at a concentration of approximately 5 to 30% of the polymer solution. To achieve a more evenly dispersed polymer microsphere-containing, melt-convertible encapsulation layer, one or both of the electrospinning and blowspinning solutions contain polymer microspheres such that they are both chemically and physically associated with the polymer nanofibrous network of the melt-convertible encapsulation layer in order to have the polymer microspheres embedded into and coated on the polymer nanofibers.

The electrode of the present invention is either or both of a cathode and an anode, wherein the cathode includes a lithium-based material selected from the group consisting of lithium manganese oxide (LMO), lithium cobalt oxide (LCO), lithium nickel Manganese cobalt oxide (NMC), and lithium iron phosphate (LFP); the anode includes a material selected from the group consisting of carbon black, carbon nanotubes, graphene, and graphite. The nanofibers in the network is made of one or more polymers of polyvinylidene fluoride (PVDF), poly(vinylidene fluoride-co-hexafluoropropylene) (PVDF-HFP), polyimide (PI), polyethylene (PE), and polypropylene (PP). In addition, the polymer microspheres is made of one or more polymers of polyvinylidene fluoride (PVDF), Poly(vinylidene fluoride-co-hexafluoropropylene)(PVDF-HFP), polyimide (PI), polyethylene (PE), and polypropylene (PP).

As shown in the present invention, the nanofibrous network in the melt-convertible encapsulation layer has high porosity in a range of approximately 50% to 90% such that the pores formed by the nanofibrous network will assist the absorption of the ion conductive electrolyte, resulting in high ionic conductivity. Meanwhile, the melt-convertible encapsulation layer also has a high surface area-to-volume ratio, such as those mentioned in U.S. Pat. No. 9,711,774 which is incorporated herein by reference in its entirety, so as to enhance the loading and improve the impedance of the battery.

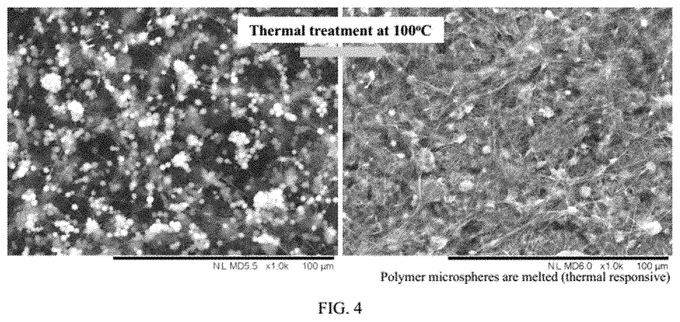

As shown in FIG. 4, the polymer microspheres of the melt-convertible encapsulation layer are not involved in the charge-discharge process of the lithium ion battery, and will melt to form a dielectric coating of the electrode so as to prevent fire or thermal runaway at a temperature approximately from 80 to 300° C. Unlike the commercial shutdown separator which is damaged or shrunk when electrode is shortened, the ionic conduction is completely blocked by the in situ formation of the dielectric coating formed by the molten polymer microspheres in the present invention. The dielectric coating is able to prevent lithium ion transportation between electrodes, resulting in shutdown of the battery.

The temperature of the dielectric coating formation in the present invention mainly depends on the properties such as the melting point and size of the polymer microspheres. With different combinations of the polymer microspheres, it is able to form different dielectric coatings at different temperatures corresponding to different specific lithium ion battery designs. In some embodiments of the present invention where the polymer microsphere is made of polyethylene (PE), the temperature for dielectric coating formation is approximately at 90° C.

### EXAMPLES

A polymer solution with polymer microspheres was prepared by dissolving the polymer PVDF materials (for fiber formation) into the organic solvent, heat at 90° C. until all the polymer had been dissolved to form a clear yellow polymer solution. The solution was allowed to cool down to room temperature and the PE microspheres (for polymer microspheres) was added and dispersed into the as prepared polymer solution. The resulting solution was allowed to sonicate at 40-50° C. for 3-5 hours until a uniform suspension of polymer microspheres in polymer solution was formed.

The as prepared polymer solution-particles suspension will be transferred into electrospinning machine for fiber formation which the polymer solution will be transformed into fiber under high voltage condition while polymer particles will be suspended around the fibers network. Lithium ion battery electrodes (either anode or cathode) will be used as the fiber collector which fibers and particles will be formed both side of electrode surface (FIG. 1). FIG. 3 depicts the schematic diagram on electro spinning.

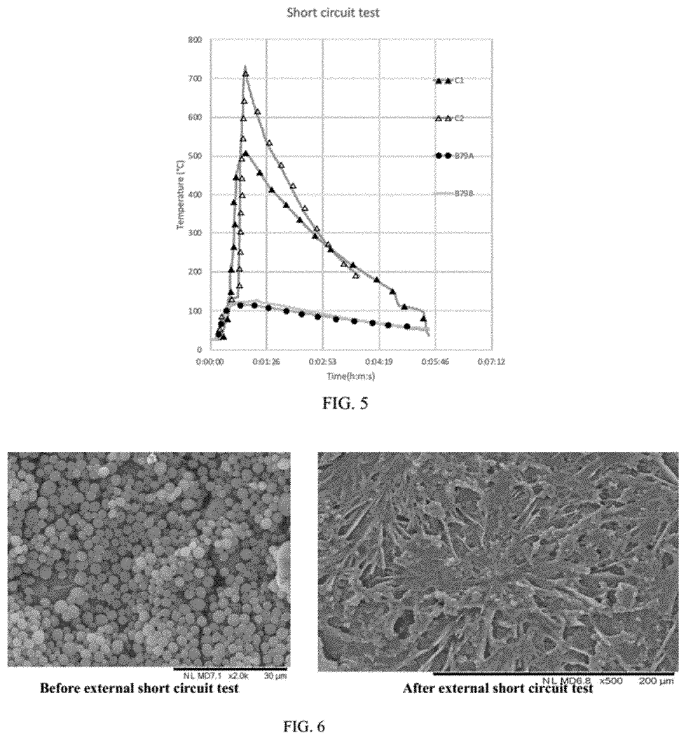

Referring to FIG. 5, the electrodes are coated with the melt-convertible encapsulation layer having the thickness about 35.8 μm (B79A) and 35.4 μm (B79B), respectively. The Tmax for B79A was about 117.3° C. at approximately 0 to 50 seconds and the Tmax for B79B was about 127.6° C. at approximately 50 to 80 seconds after the short circuit test. However, the batteries without the melt-convertible encapsulation layer coating experienced dramatic temperature rise after short circuit test, with the Tmax of C1 and C2 up to 533.4° C. and 731.4° C., respectively. The SEM images in FIG. 6 show a dielectric coating formed from the molten polymer microspheres encapsulating the electrode after short circuit test. These results suggest that the internal short-cutting is efficiently inhibited due to the melt-convertible encapsulation layer, thereby achieving a significant improvement in safety performance of the batteries.

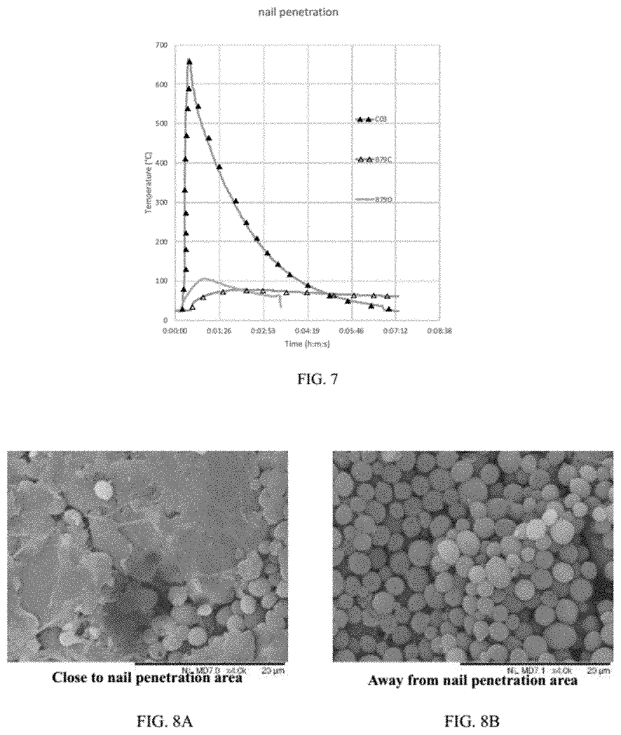

Referring to FIG. 7, the electrodes were coated with the melt-convertible encapsulation layer having a thickness of about 36.9 μm (B79C) and 36.5 μm (B79D), respectively. The Tmax for B79C was about 77.9° C. at approximately 100 to 200 seconds and the Tmax for B79D was about 106.5° C. at approximately 60 to 80 seconds after the nail penetration test. However, the batteries without the melt-convertible encapsulation layer coating experience dramatical temperature rise after penetrations, with the Tmax going up to 664.4° C. The SEM images in FIG. 8A show a dielectric coating formed from the molten polymer microspheres encapsulating the electrode close to the nail penetration area after the test. On the contrary, the structure is intact in the area away from nail penetration test shown in FIG. 8B.

It will be appreciated by those skilled in the art, in view of these teachings, that alternative embodiments may be implemented without deviating from the spirit or scope of the invention, as set forth in the appended claims. This invention is to be limited only by the following claims, which include all such embodiments and modifications when viewed in conjunction with the above specification and accompanying drawings.

1. An electrode structure for a lithium ion battery comprising:
an electrode selected from a cathode including a lithium-based material selected from the group consisting of Lithium Manganese Oxide (LMO), Lithium Cobalt Oxide (LCO), Lithium Nickel Manganese Cobalt Oxide (NMC), and Lithium Iron Phosphate (LFP), or an anode including a conductive material selected from the group consisting of carbon black, carbon nanotubes, graphene, and graphite;
a three-dimensional structure with nanofiber bonded microspheres forming a melt-convertible encapsulation layer on at least one surface of the electrode, the melt-convertible encapsulation layer comprising:
a network of nanofibers, wherein the diameter of the nanofibers is approximately from 100 to 300 nm for carrying polymer microspheres on the electrode surface via stacking of layers of polymer microspheres-coated nanofiber interconnecting network; the polymer microspheres being embedded in and coated on at least one surface of the network of nanofibers, wherein a ratio of the diameter of the polymer microspheres to the diameter of the nanofibers is over 30 and a mass ratio of the polymer microspheres to the polymer nanofibers is at least 3:1,
wherein the polymer microspheres melt to form a dielectric coating, thereby covering the surface of the electrode and nanofibers to provide a medium on spreading the molten polymer microspheres so as to prevent short circuit, fire or thermal runaway at a temperature approximately from 100 to 200° C.

2. The electrode structure for a lithium ion battery of claim 1, wherein a polydispersity of the polymer microspheres in the network of nanofibers ranges approximately from 0.6 to 1.0.

3. The electrode structure for a lithium ion battery of claim 1, wherein the nanofibers comprise one or more polymers of polyvinylidene fluoride (PVDF), poly(vinylidene fluoride-co-hexafluoropropylene)(PVDF-HFP), polyimide (PI), and polyethylene (PE), polypropylene (PP).

4. The electrode structure for a lithium ion battery of claim 1, wherein the polymer microspheres comprise one or more polymers of polyvinylidene fluoride (PVDF), poly(vinylidene fluoride-co-hexafluoropropylene)(PVDF-HFP), polyethylene (PE), and polypropylene (PP).

5. The electrode structure for a lithium ion battery of claim 1, wherein the melting point of the nanofibers ranges approximately from 180 to 200° C. and the decomposition temperature of the nanofibers ranges approximately from 300 to 500° C.

6. The electrode structure for a lithium ion battery of claim 1, wherein the melting point of the polymer microspheres ranges approximately from 80 to 200° C. and the decomposition temperature of the polymer microspheres approximately from 300 to 500° C.

7. The electrode structure for a lithium ion battery of claim 1, wherein the porosity of the network of the nanofiber is approximately from 50 to 90%.

8. The electrode structure for a lithium ion battery of claim 1, wherein the coverage rate of melt-convertible the encapsulation layer covering at least one surface layer of the electrode is approximately from 50 to 80%.

9. The electrode structure for a lithium ion battery of claim 1, wherein the melt-convertible encapsulation layer is fabricated by one or both of electrospinning and blowspinning.

10. The electrode structure for a lithium ion battery of claim 1, wherein the thickness of the melt-convertible encapsulation layer is approximately from 10-50 μm.

11. The electrode structure for a lithium ion battery of claim 1, wherein the polymer microspheres have an average size of 1 to 10 μm.

12. The electrode structure for a lithium ion battery of claim 11, wherein the polymer microspheres have an average size of 1 to 3 μm.

13. The electrode structure for a lithium ion battery of claim 1, wherein a diameter of the nanofibers is from 100 to 300 nm.

14. The electrode structure for a lithium ion battery of claim 1, wherein a ratio of the diameter of the polymer microspheres to the diameter of the nanofibers is 30.

15. A lithium ion battery comprising the electrode structure of claim 1 comprising at least an anode, a cathode, a separator and at least one three-dimensional nanofiber-microspheres-incorporated, melt-convertible encapsulation layer being applied on at least one surface of each of the anode and cathode in the absence of an order that the anode must be followed by an encapsulation layer, the separator, and then another encapsulation layer followed by the cathode, or vice versa.
